(19) United States
(12) Patent Application Publication
(10) Pub. No.: US 2007/0211180 A1
(43) Pub. Date: Sep. 13, 2007

(54) Optical Engine Apparatus And Projection Television Using The Same

(75) Inventors: Jean Hur, Seongnam-si (KR); Chul-Min Park, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Gyeonggi-do (KR)

(21) Appl. No.: 11/569,574

(22) PCT Filed: Jan. 25, 2005
(86) PCT No.: PCT/KR05/00203

§ 371 Date: Nov. 24, 2006

(30) Foreign Application Priority Data
May 25, 2004 (KR) 10-2004-0037300

(51) Int. Cl. H04N 5/64

(52) U.S. Cl. 348/744; 348/E05.128

(57) ABSTRACT

A projection television including a light source emitting light; and color wheel including a plurality of color filters provided in front of the light source and transmitting the light from the light source, a driver rotatably driving the plurality of color filters, and a supporter having a first side coupled to the driver and a second side coupled to the plurality of color filters so as to rotatably support the plurality of color filters, the driver being provided in a center portion of the color wheel, the plurality of color filters are provided around an edge of the color wheel being spaced from the driver, and a heat barrier being provided between the driver and the plurality of color filters to prevent heat generated due to the plurality of color filters from being transmitted to the driver. Thus, a projection television having a color filter absorbing heat generated from the light source disposed separately from the driver so as to prevent functional quality of the color wheel from being degraded due to the heat is provided.

### FIELD OF THE INVENTION

The present general inventive concept relates to a projection television, and more particularly, to a projection television having an improved color wheel to prevent heat generated from a color filter from being directly transmitted to a driving part.

### BACKGROUND ART

Generally, a projection television applies a mechanism of a projector which uses a mirror and an optical lens to display an image by magnifying and projecting an image beam onto a screen. Such a conventional projection television is classified into a cathode ray tube (CRT) type, a liquid crystal display (LCD) type and a digital light processing (DLP) type depending on the type of display devices generating an image from signalized image information.

As shown in FIG. 1, a conventional projection television 101 comprises a casing 110 forming an external appearance; a display 120 provided inside the casing and forming an image; an optical engine unit 130 provided below the display 120 and projecting an image beam onto the display 120 through a reflection mirror 121; a lamp assembly 140 provided adjacent to the optical engine unit 130 and comprising a light source 141 supplying light to the optical engine unit 130; and a fan 180 provided at a side portion of the lamp assembly 140 and intensively cooling down the side portion of the lamp assembly 140.

The casing 110 comprises a front casing 111 and a rear casing 112 respectively provided in a front portion and a rear portion forming the external appearance. The front casing 111 comprises a front frame 113 coupled to the display 120 which forms the image; and a bottom frame 114 bent to a rear direction from the front frame 113 and to which the optical engine unit 130 and the lamp assembly 140 are mounted. In an upper portion of the rear casing 112 is provided the reflection mirror 121 reflecting the image beam from the optical engine unit 130 to the display 120, and a lower cover 115 coupled to the front casing 111 is provided in a lower portion of the rear casing 112.

The optical engine unit 130 comprises a color wheel 150 selectively sorting the light from the light source 141 into light of red (R), green (G) and blue (B); an optical engine part 131 comprising a light tunnel (not shown) uniformizing the light from the color wheel 150; a digital micromirror device (DMD) 132 as a display panel generating the image beam with the light transmitted from the optical engine part 131 by adjusting an angle of reflection for each pixel; and a projection lens 134 projecting the image beam generated by the DMD 132 to the reflection mirror 121.

The color wheel 150 of the optical engine part 131 is shaped like a disk, and comprises a driver 160 placed in a center portion of the color wheel 150 and driving the color wheel 150 to be rotated; and a plurality of color filters 161 radially formed centering on the driver 160 and selectively filtering the light from the light source 141 by light of red (R), green (G) and blue (B).

Thus, according to the conventional projection television 101, the color wheel 150 selectively sorts the light from the light source 141 by light of red (R), green (G) and blue (B), and the light tunnel uniformizes the light passing through the color wheel 150. The uniformized light forms the image beam by the DMD 132 and the image beam is projected to the display 120 through the projection lens 134 and the reflection mirror 121.

However, this conventional projection television 101 has problems in that the color filters 161 absorbing or reflecting the light from the light source 141 are placed on a traveling path of the light and adjacently coupled to the driver 160, and thus heat generated from the light source 141 is directly transmitted to the driver 160 by the color filter 161, causing the color wheel 150 to malfunction.

Further, the fan 142 of the conventional projection television 101 is provided only at the side portion of the lamp assembly 140, and thus inefficiently cools down the light source 141.

### DISCLOSURE OF INVENTION

Accordingly, it is an aspect of the present general inventive concept to provide a projection television having a color filter absorbing heat generated from a light source disposed separately from a driver so as to prevent functional quality of a color wheel from being degraded due to the generated heat.

Another aspect of the present general inventive concept is to provide a projection television cooling down a front portion of a light source by using a color wheel placed in front of the light source.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a projection television comprising a light source emitting light; and a color wheel comprising a plurality of color filters provided in a front portion of the light source and transmitting the light from the light source, a driver rotatably driving the plurality of color filters, and a supporter having a first side coupled to the driver and a second side coupled to the plurality of color filters so as to rotatably support the plurality of color filters, the driver being provided in a center portion of the color wheel, the plurality of color filters being provided around an edge of the color wheel being spaced from the driver, and a heat barrier being provided between the driver and the plurality of color filters to prevent heat generated due to the plurality of color filters from being transmitted to the driver.

According to an embodiment of the present general inventive concept, the heat barrier forms a through hole to provide circulation of air.

According to an embodiment of the present general inventive concept, the heat barrier comprises a fan cooling down the light source.

According to an embodiment of the present general inventive concept, the fan is integrally formed with the supporter so as to rotate in accordance with rotation of the color wheel. According to an embodiment of the present invention, a fan is provided in an outer portion of the plurality of color filters and coupled to the color wheel to cool down the light source.

### BRIEF DESCRIPTION OF DRAWINGS

These and/or other ,aspects and advantages of the present general inventive concept will become apparent and more readily appreciated from the following description of the embodiments, taken in conjunction with the accompany drawings of which:

FIG. 1 is an exploded perspective view of a conventional projection television;

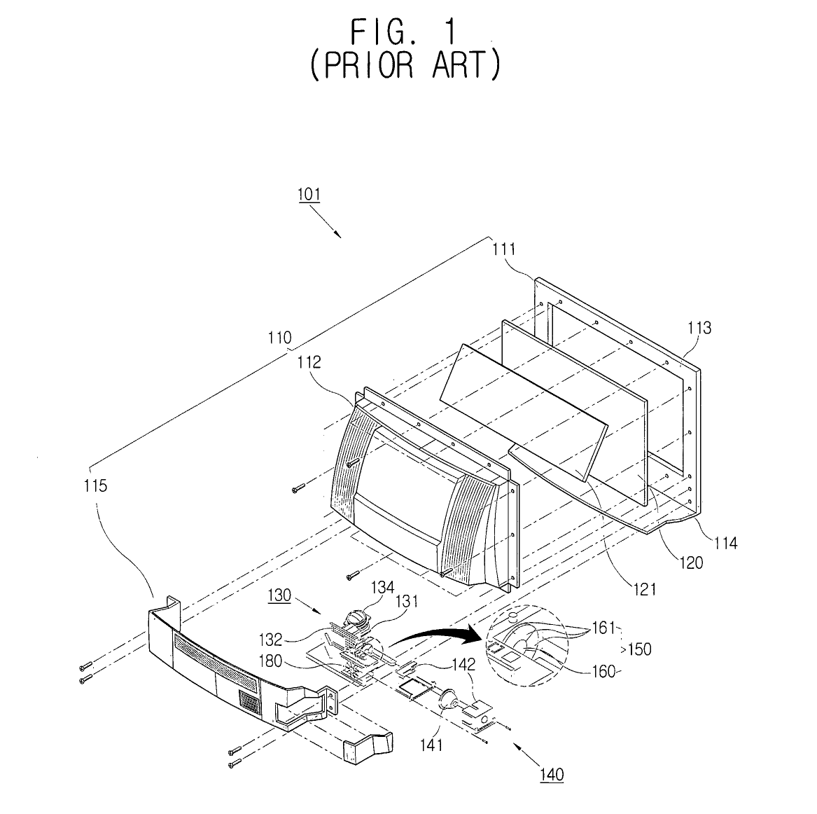

FIG. 2 is an exploded perspective view of a projection television according to an embodiment of the present general inventive concept;

FIG. 3 is a schematically exploded perspective view illustrating an optical alignment of the projection television in FIG. 2.

FIG. 4 is an exploded perspective view of a color wheel unit and a light source of the projection television according to FIG. 2;

FIG. 5 is an exploded perspective of the color wheel in FIG. 4;

FIG. 6 is an exploded side view of an airflow flowing from the color wheel to the light source of the projection television according to FIG. 2;

FIG. 7 is an exploded perspective view of a color wheel of a projection television according to another embodiment of the present general inventive concept; and

FIG. 8 is an exploded perspective view of a color wheel of a projection television according to yet another embodiment of the present general inventive concept.

### MODES FOR CARRYING OUT THE INVENTION

Reference will now be made in detail to the embodiments of the present general inventive concept, examples of which are illustrated in the accompanying drawings, wherein like reference numerals refer to like elements throughout.

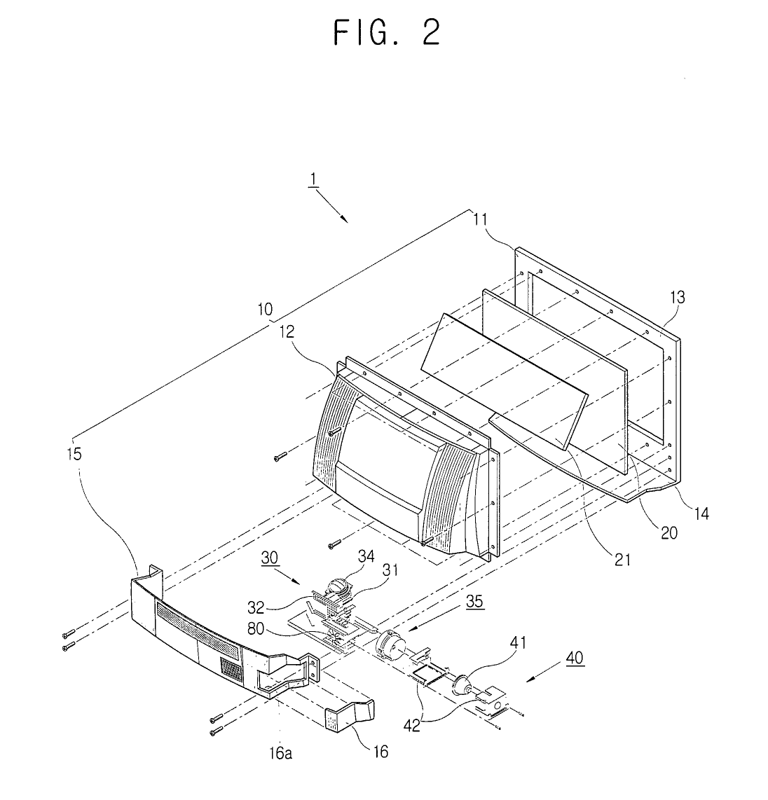

As shown in FIG. 2, a projection television 1 according to an embodiment of the present general inventive concept comprises a casing 10 forming an external appearance; a display 20 provided inside the casing 10 and forming an image; an optical engine unit 30 provided below the display 20 and projecting an image beam to the display 20 through a reflection mirror 21; a lamp assembly 40 placed adjacent to the optical engine unit 30 and comprising a light source 41 supplying light to the optical engine unit 30; and a fan 80 provided in a side portion of the lamp assembly 40 and intensively cooling down the side portion of the light source 41.

The casing 10 comprises a front casing 11 and a rear casing 12 respectively placed in a front portion and a rear portion of the display 20 forming the external appearance.

The front casing 11 comprises a front frame 13 coupled to the display 20; and a bottom frame 14 bent rearward in the front frame 13 and to which the optical engine unit 30 and the lamp assembly 40 are coupled.

In an upper portion of the rear casing 12 is provided the reflection mirror 21 reflecting the image beam from the optical engine unit 30 to the display 20, and a lower cover 15 is provided in a lower portion of the rear casing 12 and coupled to the front casing 11. In a side of the lower cover 15 are provided an opening 16a injecting/ejecting the lamp assembly 40 therethrough, and an opening cover 16 coupled thereto and opening/closing the opening 16a.

The optical engine unit 30 comprises an optical engine part 31; a display panel 32; and a projection lens 34.

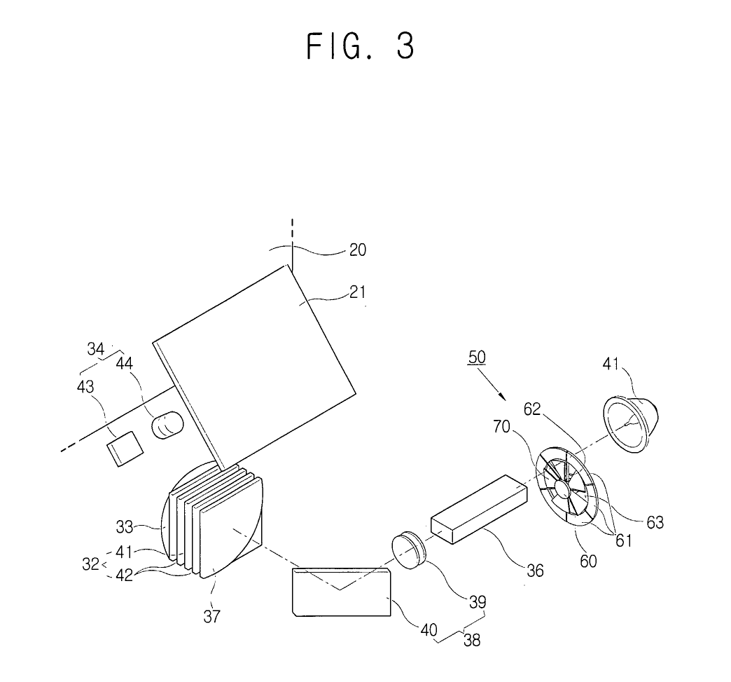

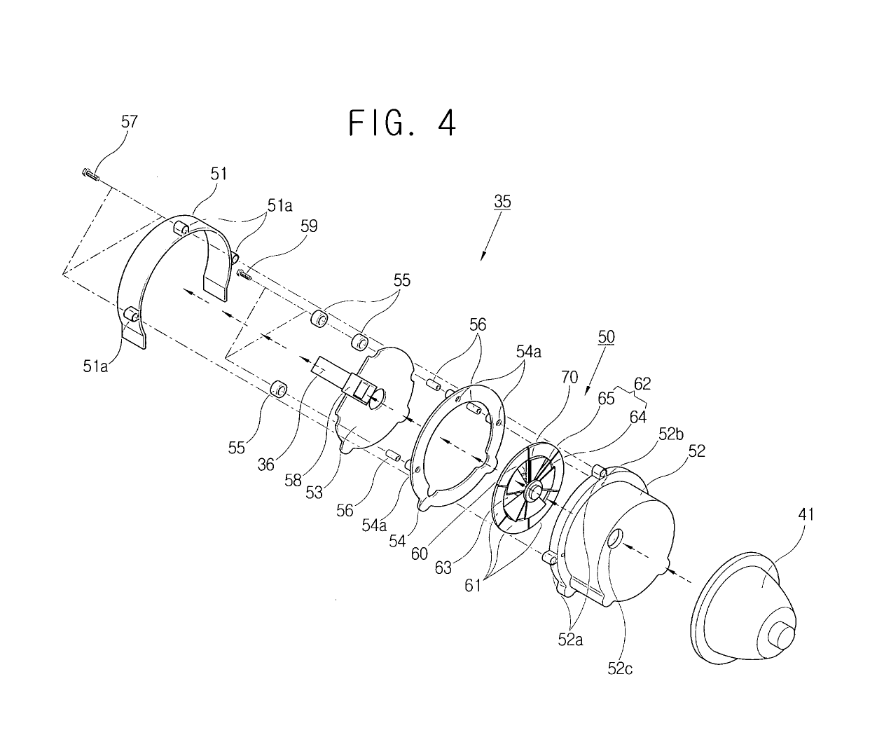

As shown in FIGS. 3 and 4, the optical engine part 31 comprises a color wheel unit 35 having a color wheel 50 selectively sorting the light from the light source 41 into light of red (R), green (G) and blue (B); a light tunnel 36 uniformizing the light from the color wheel unit 50; and a lens group 38 passing therethrough or reflecting the light passed through the light tunnel 36 to each of many pixels in the display panel 32.

The light emitted from the light source 41 is passed through the color wheel 50 rotatably provided in front of the light source 41 and sorted into light of red (R), green (G) and blue (B). The light sorted into a given color by passing through the color wheel 50 is uniformized by the light tunnel 36. Thus, the uniformized light passes through the lens group 38 comprising an image lens 38a and a cold mirror 38b, passing therethrough visible light and reflecting ultra violet rays, and almost in a parallel line goes to the display panel 32 via a first focus lens 37 focusing the incident light. The display panel 32 comprises a display device 32a and polarizers 32b provided in a front and a rear of the display device 32a, and generates an image from the light emitted from the light source 41 by employing the mechanism of the display device 32a. The light passed through the display panel 32 is passed through a second focus lens 33 and reflected by a reflection mirror inclinedly placed in a rear portion of the display 20 via the projection lens 34. The projection lens 34 comprises the reflection mirror 43 determining a focal length and the size of an image magnified corresponding to the focal length; and a plurality of lenses 44. Then, the reflected light is magnified and displayed on the display 20. Herein, the display panel 32 comprises a digital micromirror device (DMD), and creates the image from the incident light from the lens group 38 by adjusting a reflection angle for each pixel.

The color wheel unit 35 comprises the color wheel 50 selectively transmitting the light from the light source 41; a first cover 51 and a second cover 52 forming an external appearance of the color wheel 50; a wheel bracket 53 provided between the first cover 51 and the second cover 52 while mounting the color wheel 50 thereon, and comprising a light tunnel holder 58 supporting an end of the light tunnel 36; and a buffer 54 absorbing vibration from the color wheel 50 so as to prevent the vibration from being transmitted to the first cover 51 and the second cover 52 through the wheel bracket 53.

The first cover 51 and the second cover 52 are coupled by a first screw 57. Herein, the first screw(s) 57 passes through a respective first through hole 51a of the first cover 51 and is coupled to a respective first coupling hole 52a so as to connect the first cover 51 and the second cover 52. Further, the buffer 54 is coupled to the second cover 52 by a second screw(s) 59. Herein, the second screw(s) 59 passes through a respective second through hole 54a formed in the buffer 54 and is coupled to a respective second coupling hole 52b of the second cover 52 so as to connect the buffer 54 and the second cover 54. Here, a respective buffering washer 55 and a respective bushing 56 may be coupled to the respective second screw 59 so as to absorb the vibration of the color wheel 50 transmitted to the first cover 51 and the second cover 52. The second cover 52 may comprise a light through hole 52c in a side thereof to provide a traveling path of the light (refer to an arrow direction in FIG. 4) emitted from the light source 41 and directed toward a given position of the color wheel 50 to pass through the light tunnel 36.

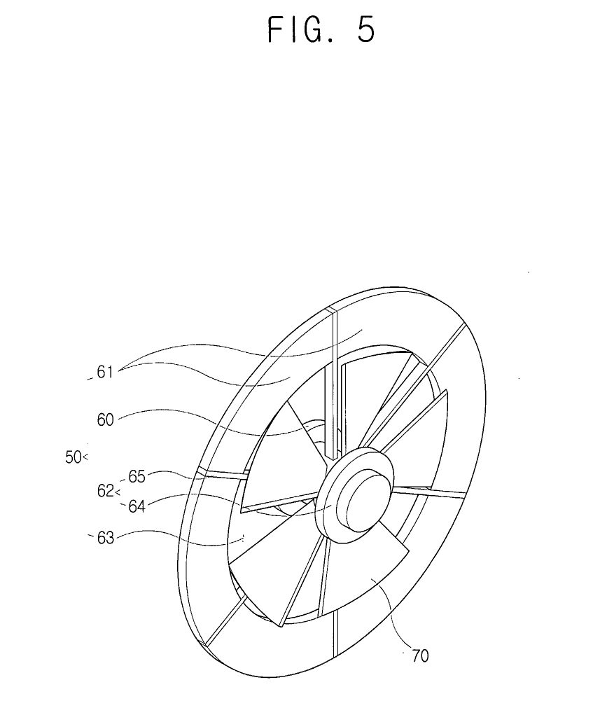

As shown in FIG. 5, the color wheel 50 comprises a plurality of disk-type color filters 61 provided around an edge of the traveling path of the light, and selectively sorting the light into red (R), green (G) and blue (B) components; and a driver 60 provided in a center portion of the color wheel 50 being spaced from the plurality of color filters 61 and driving the plurality of color filters 61 to be sequentially rotated on the traveling path of the light; a driving supporter 64 having an end coupled to the driver 60; and a supporter 62 comprising a filter supporter 65 radially provided in the driving supporter 64 and coupling the plurality of color filters 61. Further, the color wheel 50 comprises a heat barrier 63 provided between the driver 60 and the plurality of color filters 61 and barricading heat generated due to rotation of plurality of color filters 61, so as to prevent the heat from being transmitted to the driver 60. Herein, the heat barrier 63 can be formed as a through hole so that air can pass therethrough while preventing the heat generated from the plurality of color filters 61 and the light source 41 from being directed to the driver 60.

The plurality of color filters 61 are placed on the traveling path of the light emitted from the light source 41, and each segment of the plurality of color filters 61 is composed of consecutive red, green and blue color filters. As previously described, the respective segments of the plurality of color filters 61 are coupled to the radial filter supporter 65, forming a ring shape. Typically, the color filter is made of flat glasses respectively coated with red, green and blue colors, and then each of the glasses is coupled to the supporter 62 after respectively being cut into a given size. Herein, the size of the color filter 61 can be reduced as long as the light on the traveling path (refer to the arrow in FIG. 4) can pass therethrough without loss of light, and thereby increasing yield and productivity. Herein, since the color filter 61 and the driver 60 are separately placed, the amount of the heat transmitted from the color filter 61 to the driver 60 is comparatively less than that of a conventional color wheel of which a color filter and a driver are adjacently coupled to each other, and thereby preventing performance quality of the color wheel 50 from being degraded.

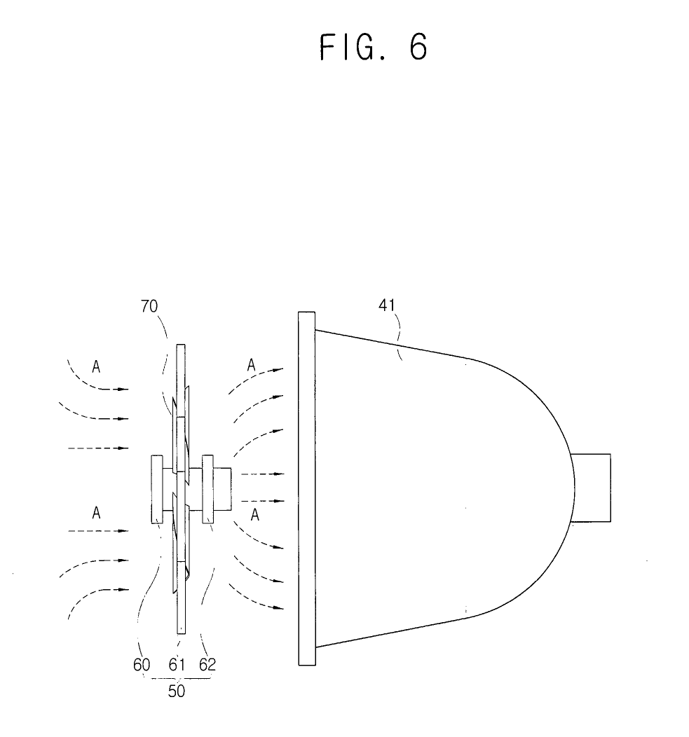

The heat barrier 63 of the color wheel 50 comprises a fan 70 supplying air. The fan 70 may be integrally designed with the supporter 62 so as to be inclined at an angle of a given degree, and thus the fan 70 rotates according to the rotation of the color wheel 50 driven by the driver 60. Thus, as shown in FIG. 6, air A is supplied to a front portion of the light source 41 by the fan 70 so as to directly cool down the front portion of the light source 41. Accordingly, the fan 70 in the heat barrier 50 and the fan 80 (refer to FIG. 2) in the side portion of the light source 41 can efficiently cool down the light source 41.

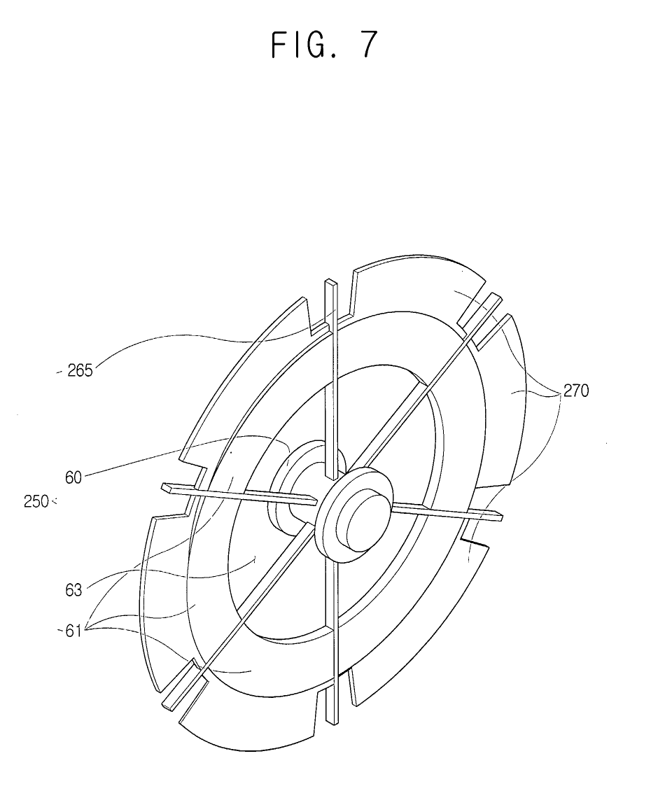

FIG. 7 is a perspective view illustrating a color wheel of a projection television according to another embodiment of the present general inventive concept. As shown therein, the present embodiment differs from the previous embodiment in a position of a fan 270. A fan 270 is provided in an outer portion of a color filter 61 to cool down a light source (not shown). More particularly, a color wheel 250 comprises a heat barrier 63 formed as a through hole so that air can be supplied to a driver 60 and the color filter 61, and the fan 270 is formed in the outer portion of the color filter 61 to cool down the light source. Herein, lateral sides of the fan 270 are supported by a filter supporter 265 extended to the outer portion of the color filter 61, and thus the fan 270 is inclined at an angle of a given degree to smoothly supply the air in a front portion of the light source.

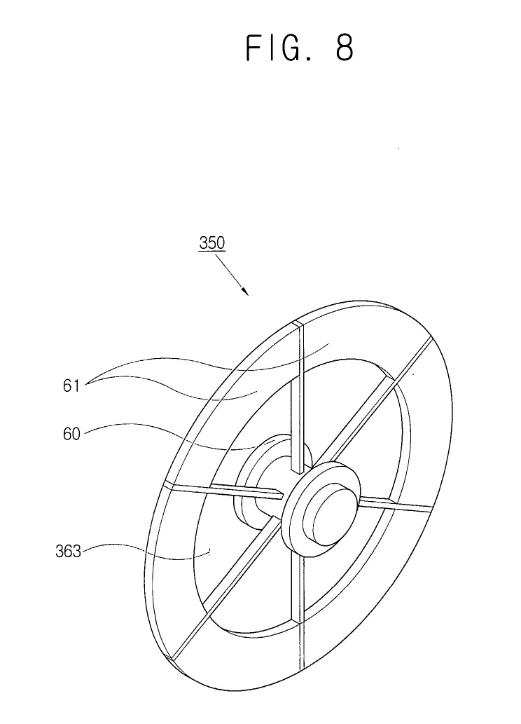

FIG. 8 is a perspective view of a color wheel of a projection television according to another embodiment of the present general inventive concept. As shown therein, according to the present embodiment of FIG. 8, no fan is provided either in an inner portion or an outer portion of a color filter, and this makes the present embodiment differ from the previous embodiments. Instead, a heat barrier 363 is penetratingly provided between a color filter 61 and a driver 60, and thus air flows through the heat barrier 363 and is supplied to the color filter 61 when a color wheel 350 rotates. Accordingly, the heat which the color filter 61 absorbs from a light source (not shown) is emitted out through the heat barrier, and thus the least amount of the heat is transmitted to the driver 60. Therefore, a rotation shaft of the driver is not worn away due to the heat, thereby preventing performance quality of the color wheel 350 from being degraded.

According to the foregoing embodiments of the present general inventive concept, a heat barrier formed like a through hole is provided between a color filter and a driver so that air can pass therethrough, thereby preventing heat transmitted to the color filter, from a light source, from being transmitted to the driver.

Meanwhile, the foregoing embodiments employ a digital micromirror device (DMD) as a display panel, but a liquid crystal display (LCD) or liquid crystal on silicon (LCOS) may be employed as the display panel.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A projection television comprising:
a light source emitting light; and
a color wheel comprising a plurality of color filters provided in front of the light source and transmitting the light from the light source, a driver rotatably driving the plurality of color filters, and a supporter having a first side coupled to the driver and a second side coupled to the plurality of color filters so as to rotatably support the plurality of color filters,
the driver being provided in a center portion of the color wheel, the plurality of color filters being provided around an edge of the color wheel and spaced from the driver, and a heat barrier being provided between the driver and the plurality of color filters to prevent heat generated due to the plurality of color filters from being transmitted to the driver.

2. The projection television according to claim 1, wherein the heat barrier forms a through hole providing circulation of air.

3. The projection television according to claim 2, wherein the heat barrier comprises a fan cooling down the light source.

4. The projection television according to claim 3, wherein the fan is integrally formed with the supporter so as to rotate in accordance with rotation of the color wheel.

5. The projection television according to claim 1, wherein a fan is provided in an outer portion of the plurality of color filters and coupled to the color wheel to cool down the light source.

6. An optical engine apparatus, comprising:
a light source emitting light;
an optical engine part receiving light from the light source, the optical engine part comprising a color wheel unit including a color wheel, a plurality of color filters provided along a circumference of the color wheel and selectively sorting the received light into red, green and blue light, a cooling unit, and a driver provided at a rotation axis of the color wheel and the cooling unit to drive the plurality of color filters to be sequentially rotated through the traveling path of the emitted light;
a display panel to receive the sorted light from the color wheel and generating an image therefrom; and
a projection lens to project the generated image onto a display.

7. The optical engine apparatus according to claim 6, wherein the color wheel unit further includes:
a light tunnel uniformizing the sorted light from the color filters;
a first cover and a second cover forming an external appearance of the color wheel;
a wheel bracket provided between the first cover and the second cover while mounting the color wheel thereon; and
a light tunnel holder supporting an end of the light tunnel.

8. The optical engine apparatus according to claim 7, wherein the color wheel unit further includes:
a buffer positioned between the wheel bracket and the second cover to absorb vibration from the color wheel to prevent the vibration from being transmitted to the first cover and the second cover through the wheel bracket.

9. The optical engine apparatus according to claim 6, wherein the cooling unit comprises a heat barrier preventing heat from being transmitted from the color filters to the driver.

10. The optical engine apparatus according to claim 6, wherein the cooling unit comprises a heat barrier and a fan combination preventing heat from being transmitted from the color filters to the driver.

11. The optical engine apparatus according to claim 10, wherein the fan is provided in an outer portion of the plurality of color filters and coupled to the color wheel to cool down the light source.

12. The optical engine apparatus according to claim 10, wherein the heat barrier is a through hole formed in the color wheel to allow air to pass therethrough and preventing heat generated from the plurality of color filters and the light source from being directed to the filter.

13. An optical engine apparatus, comprising:
a light source;
a color wheel unit comprising:
a color wheel,
a plurality of color filters at an outer circumference of the color wheel to sort the emitted light into red, blue and green light,
a cooling unit to cool the color wheel, and
a driver driving the color filters to sequentially rotate through the emitted light;
a display panel to receive the sorted light and form an image therefrom; and
a projection lens to receive the formed image and projection the formed image onto a display.

14. The optical engine apparatus according to claim 13, wherein the cooling unit comprises:
a heat barrier extending between the driver and the plurality of color filters to absorb heat generated from the light source and the plurality of color filters and to maintain a temperature of the driver within a predetermined range; and
a fan extending from the driver to circulate air within the color wheel unit.

15. The optical engine apparatus according to claim 13, wherein the cooling unit comprises:
a heat barrier extending between the driver and the plurality of color filters to absorb heat generated from the light source and the plurality of color filters and to maintain a temperature of the driver within a predetermined range; and
a fan extending along an outer periphery of the plurality of color filters to circulate air within the color wheel.

16. The optical engine apparatus according to claim 13, wherein the cooling unit comprises a heat barrier extending between the driver and the plurality of color filters to absorb heat generated from the light source and the plurality of color filters and to maintain a temperature of the driver within a predetermined range.
